(19) United States
(12) Patent Application Publication
(10) Pub. No.: US 2025/0383559 A1
(43) Pub. Date: Dec. 18, 2025

(54) POLARIZATION ANGLE MODULATOR AND POLARIZING DEVICE

(71) Applicant: OMNIVISION SEMICONDUCTOR (SHANGHAI) CO., LTD., Shanghai (CN)

(72) Inventor: Chun-Sheng FAN, Hsinchu City (TW)

(21) Appl. No.: 18/778,568

(22) Filed: Jul. 19, 2024

(30) Foreign Application Priority Data
Jun. 12, 2024 (CN) 202410758778.2

(51) Int. Cl. G02F 1/01; G02F 1/133; G02F 1/13363; G02F 1/1337; G02F 1/1343; G02F 1/1347

(52) U.S. Cl. CPC G02F 1/0136; G02F 1/13306; G02F 1/133638; G02F 1/1337; G02F 1/134309; G02F 1/1347

(57) ABSTRACT

A polarization angle modulator and a polarizing device are disclosed. The polarization angle modulator includes a first quarter wave plate, a first liquid-crystal phase modulator, a linearly polarizing wave plate, a second liquid-crystal phase modulator and a second quarter wave plate, which are sequentially stacked from the bottom upwards. The first quarter wave plate is provided on its lower surface with a plurality of electrodes for external connection of upper and lower electrode layers of the first liquid-crystal phase modulator and of upper and lower electrode layers of the second liquid-crystal phase modulator. This polarization angle modulator is an integrally-formed single-piece modulator. All electrode control and electrical distribution tasks can be accomplished at a lower surface of first quarter wave plate, allowing for easier packaging. Mass production can be easily achieved using a wafer stacking process. The polarizing device of the present invention can be provided as a simple package.

### CROSS-REFERENCE TO RELATED APPLICATION

This application claims the priority of Chinese patent application number 202410758778.2, filed on Jun. 12, 2024, the entire contents of which are incorporated herein by reference.

### TECHNICAL FIELD

The present invention pertains to the field of image sensor manufacturing, and particularly relates to a polarizing device.

### BACKGROUND

Apart from brightness and colors, polarized image sensors can capture polarization information that regular image sensors are not able to detect. They are often used in detection of scratches on the surfaces of objects and particles, distortion identification, shape recognition and other conventionally difficult-to-detect applications.

In a polarized image sensor, a polarizer is added above a photodiode of each pixel. The polarizers are wire grid polarizers (WGPs) with different polarization angles (0, 45, 90 and 135 degrees), which are positioned above respective individual pixels. The pixels are organized into sets each including four pixels and serving as a computational unit. Each WGP transmits perpendicularly vibrating light and blocks light that vibrates horizontally. Each polarization pixel is made up of four WPG sub-pixels. That is, there is a respective WGP above each WPG sub-pixel. Such an image sensor can output four images with different polarization phases, which are then optimized and combined by software into a perfect image. Fabrication of the WGPs oriented in the four different directions suffers from critical dimension variation, which leads to large sparsity and low quantum efficiency.

### SUMMARY

It is an objective of the present invention to provide a polarization angle modulator and a polarizing device. The polarization angle modulator is an integrally-formed single-piece which provides a completely electrically controllable and adjustable grating effect, dispenses with the use of WPG sub-pixels and enables maximum output quantum efficiency of each pixel. All electrode control and electrical distribution tasks can be accomplished at a lower surface of a first quarter wave plate in the modulator, allowing for easier packaging. Mass production can be easily achieved using a wafer stacking process. The polarizing device can be provided as a simple package. Moreover, it has an extremely large aperture ratio and can provide light of adjustable and controllable polarizations. These impart enhanced quantum efficiency to the polarizing device and can eliminate reflections.

The present invention provides a polarizing device including:
a first quarter wave plate, a first liquid-crystal phase modulator, a linearly polarizing wave plate, a second liquid-crystal phase modulator and a second quarter wave plate, which are sequentially stacked from the bottom upwards,
a lower surface of the first quarter wave plate provided with a plurality of electrodes, the plurality of electrodes configured for external connection of an upper electrode layer and a lower electrode layer of the first liquid-crystal phase modulator as well as external connection of an upper electrode layer and a lower electrode layer of the second liquid-crystal phase modulator.

Additionally, the first and second liquid-crystal phase modulators may be of the same structure and each include a lower base plate, the lower electrode layer, a lower alignment layer, a liquid crystal layer, an upper alignment layer, the upper electrode layer and an upper base plate, which are sequentially disposed from the bottom upwards.

Additionally, the electrodes may include a first electrode and a second electrode disposed at opposite ends of a first diagonal defined by the first quarter wave plate, the first electrode electrically connected to the upper electrode layer of the first liquid-crystal phase modulator, the second electrode electrically connected to the lower electrode layer of the first liquid-crystal phase modulator.

Additionally, the first electrode may extend through the first quarter wave plate and the lower base plate of the first liquid-crystal phase modulator and contact and be thus electrically connected to the upper electrode layer of the first liquid-crystal phase modulator, and the second electrode may extend through the first quarter wave plate and the lower base plate and the lower electrode layer of the first liquid-crystal phase modulator and be electrically connected to the lower electrode layer.

Additionally, the electrodes may include a third electrode and a fourth electrode disposed at opposite ends of a second diagonal defined by the first quarter wave plate, the third electrode electrically connected to the lower electrode layer of the second liquid-crystal phase modulator, the fourth electrode electrically connected to the upper electrode layer of the second liquid-crystal phase modulator.

Additionally, the third electrode may extend through the first quarter wave plate, the first liquid-crystal phase modulator, the linearly polarizing wave plate and the lower base plate and the lower electrode layer of the second liquid-crystal phase modulator and be electrically connected to the lower electrode layer, and the fourth electrode may extend through the first quarter wave plate, the first liquid-crystal phase modulator, the linearly polarizing wave plate and the lower base plate of the second liquid-crystal phase modulator to the upper electrode layer and be electrically connected to the upper electrode layer.

Additionally, an optical axis of the first quarter wave plate may be parallel to an axis of polarization of the linearly polarizing wave plate, an optical axis of the second quarter wave plate may be parallel to the axis of polarization of the linearly polarizing wave plate;
a slow axis of the liquid crystal layer in the first liquid-crystal phase modulator forms an angle of 45 degrees with the axis of polarization of the linearly polarizing wave plate; and
a slow axis of the liquid crystal layer in the second liquid-crystal phase modulator forms an angle of 45 degrees with the axis of polarization of the linearly polarizing wave plate.

Additionally, the first and second quarter wave plates may each have a thickness in the range of 0.4 μm to 4.0 μm , and

the first and second liquid-crystal phase modulators may each have a thickness in the range of 2.0 μm to 10.0 μm .

The present invention also provides a polarizing device including:
the polarization angle modulator as defined above; and
an image sensor, wherein the polarization angle modulator is bonded to a photosensitive side of the image sensor.

Additionally, the image sensor includes a substrate, wherein a plurality of bond pads are formed at corners of an upper surface of the substrate, the plurality of bond pads are electrically connected to the respective electrodes, and an image chip is embedded in a central portion of the substrate.

The present invention has the following benefits over the prior art:

It provides a polarization angle modulator and a polarizing device. The polarization angle modulator includes a first quarter wave plate, a first liquid-crystal phase modulator, a linearly polarizing wave plate, a second liquid-crystal phase modulator and a second quarter wave plate, which are sequentially stacked in this order from the bottom upwards. The first quarter wave plate is provided on its lower surface with a number of electrodes for external connection of upper and lower electrode layers of the first liquid-crystal phase modulator and of upper and lower electrode layers of the second liquid-crystal phase modulator. This polarization angle modulator is an integrally-formed single-piece modulator, which provides a completely electrically controllable and adjustable grating effect, dispenses with the use of WPG sub-pixels and enables maximum output quantum efficiency of each pixel. All electrode control and electrical distribution tasks can be accomplished at a lower surface of the first quarter wave plate that provides a bottom surface of the polarization angle modulator, allowing for easier packaging. Mass production can be easily achieved using a wafer stacking process. The polarizing device of the present invention can be obtained by integrating the polarization angle modulator and an image sensor in a simple package. The polarizing device has an extremely large aperture ratio and can provide light of adjustable and controllable polarizations. These impart enhanced quantum efficiency to the polarizing device and can eliminate reflections.

### BRIEF DESCRIPTION OF THE DRAWINGS

FIG. 1 is a schematic cross-sectional view of a polarization angle modulator according to an embodiment of the present invention, taken along diagonal line A-a.

FIG. 2 is a schematic cross-sectional view of a polarization angle modulator according to an embodiment of the present invention, taken along diagonal line B-b.

FIG. 3 is a top view of a polarization angle modulator according to an embodiment of the present invention.

FIG. 4 is a schematic cross-sectional view of a polarizing device according to an embodiment of the present invention, taken along diagonal line B-b.

### LIST OF REFERENCE NUMERALS

10 first liquid-crystal phase modulator; 11, 21 lower base plate; 12, 22-lower electrode layer; 13, 23 lower alignment layer; 14, 24 liquid crystal layer; 15, 25 upper alignment layer; 16, 26 upper electrode layer; 17, 27 upper base plate; 20, second liquid-crystal phase modulator; 30, linearly polarizing wave plate; 41, first quarter wave plate; 42, second quarter wave plate; 51, first electrode; 52, second electrode; 53, third electrode; 54, fourth electrode; 61, substrate; 62 bond pad; 63 image chip.

### DETAILED DESCRIPTION

The present invention will be described in greater detail below with reference to the accompanying drawings, which illustrate specific embodiments thereof. From the following description, advantages and features of the invention will become apparent. Note that the figures are provided in a very simplified form not necessarily drawn to exact scale for the only purpose of helping to explain the disclosed embodiments in a more convenient and clearer way.

For ease of description, in some embodiments disclosed herein, spatially relative terms, such as “above”, “below”, “top”, “beneath” and the like, may be used to describe one element or feature's relationship to another element or feature (or to other elements or features) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “on top of” the other elements or features. As used hereinafter, the terms “first”, “second” and the like may be used to distinguish between similar elements without necessarily implying any particular ordinal or chronological sequence. It will be understood that the terms so used are interchangeable, whenever appropriate.

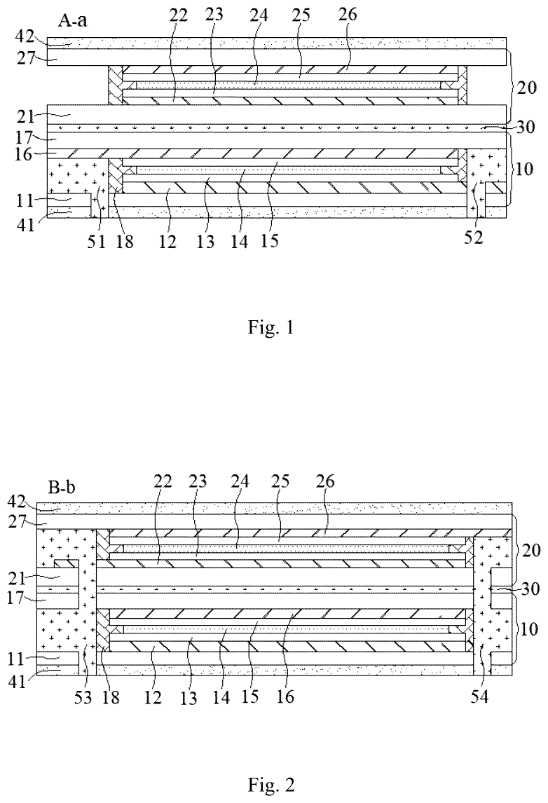

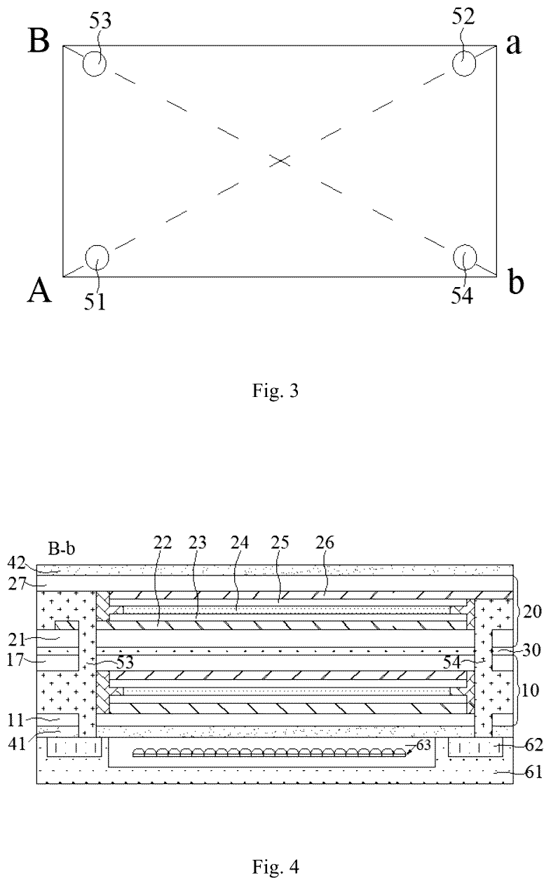

As shown in FIGS. 1 to 3, embodiments of the present invention provide a polarization angle modulator including:
a first quarter wave plate 41, a first liquid-crystal phase modulator 10, a linearly polarizing wave plate 30, a second liquid-crystal phase modulator 20 and a second quarter wave plate 42, which are sequentially stacked in this order from the bottom upwards.

The first quarter wave plate 41 is provided on its lower surface with a number of electrodes, the electrodes are configured for external connection of an upper electrode layer 16 and a lower electrode layer 12 of the first liquid-crystal phase modulator 10 as well as external connection of an upper electrode layer 26 and a lower electrode layer 22 of the second liquid-crystal phase modulator 20.

The quarter wave plates are each made of a material having anisotropic properties, which impart different refractive indices for light of different polarizations and allow it to propagate at different speeds, producing two components with a phase difference.

The first liquid-crystal phase modulator 10 and the second liquid-crystal phase modulator 20 are of the same structure. The first liquid-crystal phase modulator 10 includes a lower base plate 11, a lower electrode layer 12, a lower alignment layer 13, a liquid crystal layer 14, an upper alignment layer 15, an upper electrode layer 16 and an upper base plate 17, which are sequentially disposed in this order from the bottom upwards. The second liquid-crystal phase modulator 20 includes a lower base plate 21, a lower electrode layer 22, a lower alignment layer 23, a liquid crystal layer 24, an upper alignment layer 25, an upper electrode layer 26 and an upper base plate 27, which are sequentially disposed in this order from the bottom upwards.

An embodiment example of the first liquid-crystal phase modulator 10 is described below. Both the lower base plate 11 and the upper base plate 17 may be glass base plates, and the lower electrode layer 12 and the upper electrode layer 16 may be ITO (indium tin oxide) electrode layers attached to inner sides of the lower base plate 11 and the upper base plate 17, respectively. ITO may be sputtered and plated onto the surface of glass, producing so-called ITO glass. In practical applications, the transparent ITO electrode layers may be etched into different patterns, as desired. The liquid crystal layer 14 is provided between the lower base plate 11 and the upper base plate 17. The liquid crystal layer 14 may be sealed between the lower base plate 11 and the upper base plate 17 using a sealing adhesive (in the form of an adhesive frame surrounding and attaching to side walls of the liquid crystal layer). The upper alignment layer 15 and the lower alignment layer 13 may be polyimide (PI) layers. The lower alignment layer 13 is coated on a surface of the lower electrode layer 12, and the upper alignment layer 15 is coated on a surface of the upper electrode layer 16. Depending on the alignment patterns of liquid crystal molecules at surfaces of the liquid crystal layer, alignment layers with different properties may be used.

Liquid-crystal phase modulators, also known as liquid-crystal phase retarders, are used to retard the phase of light incident onto liquid crystal molecules by tuning the refractive index of the molecules through changing a voltage applied thereto. The liquid crystal material may be filled between two flat glass plates with plated transparent electrode and calibration layers. When a voltage of 0 V is applied across the liquid crystal material, the liquid crystal molecules are aligned parallel to the glass plates. At this time, there is a maximum refractive index difference between the O- and E-rays. As the voltage across the liquid crystal layer increases, the liquid crystal molecules rotate, increasingly reducing the refractive index difference between the O- and E-rays until the refractive indices become substantially equal. If the polarization of the incident light is in accordance with the refractive index of the O-ray, the latter will not change with the applied voltage and, therefore, the phase retardation induced by the liquid crystal material will be independent of the applied voltage. If the polarization of the incident light is in accordance with the refractive index of the E-ray, the phase retardation induced by the liquid crystal material will change as the applied voltage varies.

Molecules in a nematic-phase liquid crystal material have an order alignment, which coupled with their stretched shape, creates optical anisotropy. When an electric field is applied, the molecules align with the electric field, and their birefringence depends on their inclination. A liquid-crystal retarder with residual retardation compensation can create a retardation in the range of 0 nm to λ. A retardation that can be provided by an uncompensated liquid crystal retarder ranges from 30 nm to λ.

The electrodes include a first electrode 51 and a second electrode 52, which are disposed at opposite ends of a first diagonal Aa defined by the first quarter wave plate 41. The first electrode 51 is electrically connected to the upper electrode layer 16 of the first liquid-crystal phase modulator 10, and the second electrode 52 is electrically connected to the lower electrode layer 12 of the first liquid-crystal phase modulator 10. Specifically, the first electrode 51 extends through both the first quarter wave plate 41 and the lower base plate 11 of the first liquid-crystal phase modulator 10 and contacts and is thus electrically connected to the upper electrode layer 16 of the first liquid-crystal phase modulator. The second electrode 52 extends through the first quarter wave plate 41 and the lower base plate 11 and the lower electrode layer 12 of the first liquid-crystal phase modulator and is electrically connected to the lower electrode layer 12. The first electrode 51 and the second electrode 52 may fill gaps between the lower base plate 11 and the upper base plate 17 of the first liquid-crystal phase modulator 10 at the opposite ends of the first diagonal Aa.

The electrodes include a third electrode 53 and a fourth electrode 54, which are disposed at opposite ends of a second diagonal Bb defined by the first quarter wave plate 41. The third electrode 53 is electrically connected to the lower electrode layer 22 of the second liquid-crystal phase modulator 20, and the fourth electrode 54 is electrically connected to the upper electrode layer 26 of the second liquid-crystal phase modulator 20. Specifically, the third electrode 53 extends through the first quarter wave plate 41, the first liquid-crystal phase modulator 10, the linearly polarizing wave plate 30 and the lower base plate 21 and the lower electrode layer 22 of the second liquid-crystal phase modulator 20 and is electrically connected to the lower electrode layer 22. The fourth electrode 54 extends through the first quarter wave plate 41, the first liquid-crystal phase modulator 10, the linearly polarizing wave plate 30 and the lower base plate 21 of the second liquid-crystal phase modulator 20 to the upper electrode layer 26 and is electrically connected to the upper electrode layer 26. The third electrode 53 and the fourth electrode 54 may fill gaps between the lower base plate 11 and the upper base plate 17 of the first liquid-crystal phase modulator 10 and gaps between the lower base plate 21 and the upper base plate 27 of the second liquid-crystal phase modulator 20 at the opposite ends of the second diagonal Bb.

When a voltage is applied to the first electrode 51 and the second electrode 52, an electric field will be created between first aligned regions of the upper electrode layer 16 and the lower electrode layer 12 of the first liquid-crystal phase modulator. Tuning the magnitude of the electric field can alter a direction in which liquid crystal molecules between the first aligned regions align, achieving optical phase modulation in a thickness direction of the liquid crystal layer.

When a voltage is applied to the third electrode 53 and the fourth electrode 54, an electric field will be created between second aligned regions of the lower electrode layer 22 and the upper electrode layer 26 of the second liquid-crystal phase modulator. Tuning the magnitude of the electric field can alter a direction in which liquid crystal molecules between the second aligned regions align, achieving optical phase modulation in the thickness direction of the liquid crystal layer. All light can be quickly modulated to a predetermined polarization state in a short time.

Incident light can propagate sequentially through the second quarter wave plate 42, the second liquid-crystal phase modulator 20, the linearly polarizing wave plate 30, the first liquid-crystal phase modulator 10 and the first quarter wave plate 41 in the polarization angle modulator. In optics, polarized light can be described using the Jones calculus. Polarized light is represented by a Jones vector, and the polarization characteristics of polarizing elements are represented by Jones matrices. When polarized light crosses polarizing element(s), the resulting polarization of the emerging light is found by taking the product of the Jones matrix (matrices) of the polarizing element(s) and the Jones vector of the incident light. Accordingly, according to embodiments of the present invention, when incident light crosses the series of polarizing elements (i.e., the second quarter wave plate 42, the second liquid-crystal phase modulator 20, the linearly polarizing wave plate 30, the first liquid-crystal phase modulator 10 and the first quarter wave plate 41), a polarization angle of the emerging light can be calculated by taking the product of the Jones vector of the incident light and the Jones matrices of the polarizing elements.

In one example, an optical axis of the first quarter wave plate is parallel to an axis of polarization of the linearly polarizing wave plate, and an optical axis of the second quarter wave plate is also parallel to the axis of polarization of the linearly polarizing wave plate. A slow axis of the liquid crystal layer in the first liquid-crystal phase modulator forms an angle of 45 degrees with the axis of polarization of the linearly polarizing wave plate, and a slow axis of the liquid crystal layer in the second liquid-crystal phase modulator also forms an angle of 45 degrees with the axis of polarization of the linearly polarizing wave plate. The first and second quarter wave plates each have a thickness in the range of, for example, 0.4 μm to 4.0 μm. The first and second liquid-crystal phase modulators each have a thickness in the range of, for example, 2.0 μm to 10.0 μm .

The above-discussed polarization angle modulator of the present invention is an integrally-formed single-piece modulator, which provides a completely electrically controllable and adjustable grating effect, dispenses with the use of WPG sub-pixels and enables maximum output quantum efficiency of each pixel. All electrode control and electrical distribution tasks can be accomplished at the lower surface of the first quarter wave plate that provides a bottom surface of the polarization angle modulator, allowing for easier packaging. The first to fourth electrodes 51-54 externally connect the four electrode layers in the polarization angle modulator. That is, the four electrodes control electrical signals to and from the respective ITO layers. This enables easy mass production using a wafer stacking process.

According to the present invention, angles of fast axes of the liquid-crystal phase modulators can be tuned by changing external voltages applied to the respective liquid crystal layers. When fast axes of the quarter wave plates are fixed at given angles, light can transmit the liquid crystal layers at an angle that varies in a controlled manner. That is, a phase retardation can be tuned by adjusting the external voltages applied to the liquid crystal layers, thereby angularly shifting an axis of transmission of the linearly polarizing wave plate 30. In this way, when travelling through such architecture, a non-polarized light beam can produce light beams of different linear polarizations.

As shown in FIG. 4, embodiments of the present invention provide a polarizing device including:
a polarization angle modulator including a first quarter wave plate 41, a first liquid-crystal phase modulator 10, a linearly polarizing wave plate 30, a second liquid-crystal phase modulator 20 and a second quarter wave plate 42, which are sequentially stacked in this order from the bottom upwards, the first quarter wave plate 41 provided on its lower surface with a number of electrodes, the electrodes are configured for external connection of an upper electrode layer 16 and a lower electrode layer 12 of the first liquid-crystal phase modulator 10 as well as external connection of an upper electrode layer 26 and a lower electrode layer 22 of the second liquid-crystal phase modulator 20; and
an image sensor bonded to the polarization angle modulator.

The image sensor includes a substrate 61, the substrate 61 is formed with bond pads 62 in its peripheral surface portions. An image chip 63 is embedded in a central portion of the substrate. The first liquid-crystal phase modulator 10, the linearly polarizing wave plate 30 and the second liquid-crystal phase modulator 20 may be sequentially bonded together with an optically clear adhesive.

The polarizing device of the present invention can be obtained by integrating the polarization angle modulator and the image sensor in a simple package. The polarizing device of the present invention has an extremely large aperture ratio and can provide light of adjustable and controllable polarizations. These impart enhanced quantum efficiency to the polarizing device and can eliminate reflections.

The polarizing device of the present invention can be used, for example, in the field of intelligent transportation. In contrast to a regular camera which may not be able to capture a clear image of the interior of a vehicle due to reflections at a front windshield thereof, polarization information detected by the polarizing device can be used to reduce or eliminate the influence of reflections, allowing for clear observation of the interior of the vehicle. For regular cameras, imaging in a low-contrast or high-reflection condition is challenging. However, a polarized camera incorporating the polarizing device of the present invention can help identify hidden characteristics of materials and provide higher visual clarity than standard color and monochrome cameras. Such a polarized camera can filter out undesired reflections or glare and provide enhanced contrast by coloring an image based on polarization angles of light. Regular color and monochrome sensors can detect the intensity and wavelength of incident light, while the polarizing device for use in a polarized camera can detect light reflected, refracted or scattered at a surface and filter out light with certain polarization angle(s). As no wire grids are fabricated, pixel defects can be effectively reduced.

In summary, the present invention provides a polarization angle modulator and a polarizing device. The polarization angle modulator includes a first quarter wave plate, a first liquid-crystal phase modulator, a linearly polarizing wave plate, a second liquid-crystal phase modulator and a second quarter wave plate, which are sequentially stacked in this order from the bottom upwards. The first quarter wave plate is provided on its lower surface with a number of electrodes for external connection of upper and lower electrode layers of the first liquid-crystal phase modulator and of upper and lower electrode layers of the second liquid-crystal phase modulator. This polarization angle modulator is an integrally-formed single-piece modulator, which provides a completely electrically controllable and adjustable grating effect, dispenses with the use of WPG sub-pixels and enables maximum output quantum efficiency of each pixel. All electrode control and electrical distribution tasks can be accomplished at a lower surface of the first quarter wave plate that provides a bottom surface of the polarization angle modulator, allowing for easier packaging. Mass production can be easily achieved using a wafer stacking process. The polarizing device of the present invention can be obtained by integrating the polarization angle modulator and an image sensor in a simple package. The polarizing device has an extremely large aperture ratio and can provide light of adjustable and controllable polarizations. These impart enhanced quantum efficiency to the polarizing device and can eliminate reflections.

The embodiments disclosed herein are described in a progressive manner, with the description of each embodiment focusing on its differences from others. Reference can be made between the embodiments for their identical or similar parts. Since the method embodiments correspond to the device embodiments, they are described relatively briefly, and reference can be made to the device embodiments for more details.

The foregoing description is merely that of several preferred embodiments of the present invention and is not intended to limit the scope of the claims of the invention in any way. Any person of skill in the art may make various possible variations and changes to the disclosed embodiments in light of the methodologies and teachings disclosed hereinabove, without departing from the spirit and scope of the invention. Accordingly, any and all such simple variations, equivalent alternatives and modifications made to the foregoing embodiments based on the essence of the present invention without departing from the scope of the embodiments are intended to fall within the scope of protection of the invention.

What is claimed is:

1. A polarization angle modulator, comprising:
a first quarter wave plate, a first liquid-crystal phase modulator, a linearly polarizing wave plate, a second liquid-crystal phase modulator and a second quarter wave plate, which are sequentially stacked from the bottom upwards,
a lower surface of the first quarter wave plate provided with a plurality of electrodes, the plurality of electrodes configured for external connection of an upper electrode layer and a lower electrode layer of the first liquid-crystal phase modulator as well as external connection of an upper electrode layer and a lower electrode layer of the second liquid-crystal phase modulator.

2. The polarization angle modulator of claim 1, wherein the first liquid-crystal phase modulator and the second liquid-crystal phase modulator are of the same structure and each comprise a lower base plate, the lower electrode layer, a lower alignment layer, a liquid crystal layer, an upper alignment layer, the upper electrode layer and an upper base plate, which are sequentially disposed from the bottom upwards.

3. The polarization angle modulator of claim 2, wherein the plurality of electrodes comprise a first electrode and a second electrode disposed at opposite ends of a first diagonal defined by the first quarter wave plate, the first electrode electrically connected to the upper electrode layer of the first liquid-crystal phase modulator, the second electrode electrically connected to the lower electrode layer of the first liquid-crystal phase modulator.

4. The polarization angle modulator of claim 3, wherein the first electrode extends through the first quarter wave plate and the lower base plate of the first liquid-crystal phase modulator and contacts and is thus electrically connected to the upper electrode layer of the first liquid-crystal phase modulator, and the second electrode extends through the first quarter wave plate and the lower base plate and the lower electrode layer of the first liquid-crystal phase modulator and is electrically connected to the lower electrode layer.

5. The polarization angle modulator of claim 2, wherein the plurality of electrodes comprise a third electrode and a fourth electrode disposed at opposite ends of a second diagonal defined by the first quarter wave plate, the third electrode electrically connected to the lower electrode layer of the second liquid-crystal phase modulator, the fourth electrode electrically connected to the upper electrode layer of the second liquid-crystal phase modulator.

6. The polarization angle modulator of claim 5, wherein the third electrode extends through the first quarter wave plate, the first liquid-crystal phase modulator, the linearly polarizing wave plate and the lower base plate and the lower electrode layer of the second liquid-crystal phase modulator and is electrically connected to the lower electrode layer, and the fourth electrode extends through the first quarter wave plate, the first liquid-crystal phase modulator, the linearly polarizing wave plate and the lower base plate of the second liquid-crystal phase modulator to the upper electrode layer and is electrically connected to the upper electrode layer.

7. The polarization angle modulator of claim 1, wherein:
an optical axis of the first quarter wave plate is parallel to an axis of polarization of the linearly polarizing wave plate;
an optical axis of the second quarter wave plate is parallel to the axis of polarization of the linearly polarizing wave plate;
a slow axis of the liquid crystal layer in the first liquid-crystal phase modulator forms an angle of 45 degrees with the axis of polarization of the linearly polarizing wave plate; and
a slow axis of the liquid crystal layer in the second liquid-crystal phase modulator forms an angle of 45 degrees with the axis of polarization of the linearly polarizing wave plate.

8. The polarization angle modulator of claim 1, wherein:
the first quarter wave plate and the second quarter wave plate each have a thickness of

0. 4 μm to 4.0 μm ; and
the first liquid-crystal phase modulator and the second liquid-crystal phase modulator each have a thickness of 2.0 μm to 10.0 μm .

9. A polarizing device, comprising:
the polarization angle modulator of claim 1; and
an image sensor, wherein the polarization angle modulator is bonded to a photosensitive side of the image sensor.

10. The polarizing device of claim 9, wherein the image sensor comprises a substrate, wherein a plurality of bond pads are formed at corners of an upper surface of the substrate, the plurality of bond pads are electrically connected to the respective electrodes, and an image chip is embedded in a central portion of the substrate.
